(19) United States
(12) Patent Application Publication
(10) Pub. No.: US 2008/0045180 A1
(43) Pub. Date: Feb. 21, 2008

(54) Data transmitting method and apparatus applying wireless protected access to a wireless distribution system

(75) Inventors: Huan-Tang Yang, Beipu Township (TW); Yuan-Te Hsieh, Lioujia Township (TW)

Correspondence Address: BACON & THOMAS, PLLC, 625 SLATERS LANE, FOURTH FLOOR, ALEXANDRIA, VA, 22314, US

(73) Assignee: Arcadyan Technology Corporation, Hsinchu (TW)

(21) Appl. No.: 11/783,941

(22) Filed: Apr. 13, 2007

(30) Foreign Application Priority Data
Jul. 7, 2006 (TW) 95124911

(51) Int. Cl. H04M 1/66; H04L 9/12

(52) U.S. Cl. 455/411; 380/247; 713/171

(57) ABSTRACT

A data transmitting method of a wireless distribution system (WDS) applying an access point (AP) of a master to encrypt/decrypt data through a wireless protected access (WPA) includes the following steps. First, a second AP is selected as a peer repeater through a user interface of a first AP and a pre-shared key (PSK) is obtained through the user interface. Next, the PSK is set as a pairwise transient key (PTK) and a pairwise master key (PMK) is generated according to the PTK. Then, the PMK is transmitted the second AP. Next, an acknowledgement signal outputted from the second AP is received. Then, the PMK is stored to a group key cache and the data is encrypted/decrypted according to the PMK.

This application claims the benefit of Taiwan application Serial No. 95124911, filed Jul. 7, 2006, the subject matter of which is incorporated herein by reference.

### BACKGROUND OF THE INVENTION

1. Field of the Invention

The invention relates in general to a data transmitting method of a wireless distribution system (WDS) between access points (APs), and more particularly to a data transmitting method applying a wireless protected access (WPA) to a WDS.

2. Description of the Related Art

A data transmitting method of a conventional WDS encrypts/decrypts data in a wired equivalent private (WEP) scheme. The encryption/decryption key of the WEP system has a WEP key and an initialization vector (IV). The length of the WEP key is 40 bits, or 104 bits, and the IV has 24 bits. The WEP key and the IV form the encryption/decryption key having 64 or 128 bits. Because the WEP key is fixed and only the IV is variable, the hacker who wants to hack the network only needs to accumulate 224 IV packets in order to crack the WEP key in the data transmitting method of the conventional WDS. In 2001, Fluhrer, Mantin and Shamir disclose an article of cracking the WEP in a short period of time even if the data is encrypted/decrypted according to the key in the 128-bit WEP system. Thus, the data transmitting method of the conventional WDS has the drawback of the low information security.

### SUMMARY OF THE INVENTION

The invention is directed to data transmitting method and apparatus applying a wireless protected access (WPA) to a wireless distribution system (WDS). The data transmitting method and apparatus of the invention have the advantage of the high data security.

According to a first aspect of the present invention, a data transmitting method of a wireless distribution system (WDS) for encrypting/decrypting data through a wireless protected access (WPA) in a data transmitting system is provided. The data transmitting method includes the following steps. First, a master access point (AP) and a slave AP is provided, wherein the master and the slave AP respectively set the slave and the master AP as peer repeaters. The master and the slave AP further respectively generate a pre-shared key (PSK). Next, the master and the slave AP are enabled to set the PSK as first pairwise transient key (PTK) and second PTK and generate a first pairwise master key (PMK) and second PMK according to the first PTK and the second PTK, respectively. Then, the first PMK is transmitted to the slave AP. Next, an acknowledgement (ACK) signal is outputted from the second AP after the first PMK is received. Thereafter, the master and the slave AP are enabled to store the first PMK, and to encrypt/decrypt the data according to the first PMK, respectively.

According to a second aspect of the present invention, data transmitting system of a wireless distribution system (WDS) for encrypting/decrypting data between access points (APs) through a wireless protected access (WPA) is provided. The data transmitting system includes a master AP and a slave AP. The master AP includes first wireless module, first user interface, and first processing unit. The first user interface sets the slave AP as a peer repeater and sets a PSK. The first processing unit sets the PSK as first PTK and thus generates first PMK. The first processing unit outputs the first PMK to the slave AP. The first processing unit receives an ACK signal outputted from the slave AP and then stores the first PMK, and encrypts/decrypts the data according to the first PMK. The slave AP includes second wireless module, second user interface, and second processing unit. The second user interface sets the master AP as another peer repeater and sets the PSK. The second processing unit sets the PSK as second PTK and generating second PMK. The second processing unit receives the first PMK outputted form the first processing unit, outputs the ACK signal to the master AP through the second wireless module when receiving the first PMK through the second wireless module, stores the first PMK and encrypts/decrypts the data according to the first PMK so as to transmit the data to the master AP.

The invention will become apparent from the following detailed description of the preferred but non-limiting embodiments. The following description is made with reference to the accompanying drawings.

### BRIEF DESCRIPTION OF THE DRAWINGS

FIG. 1 is a circuit block diagram showing a transmission system, which applies the WPA to the WDS according to a preferred embodiment of the invention.

FIGS. 2A and 2B are flow charts showing a data transmitting method, which applies the WPA to the WDS in the AP 100a of FIG. 1.

FIG. 3 is a flow chart showing a data transmitting method, which applies the WPA to the WDS in the AP 100b of FIG. 1.

### DETAILED DESCRIPTION OF THE INVENTION

The invention applies a wireless protected access (WPA) to the data transmitting method and apparatus of a wireless distribution system (WDS) and mainly applies the WPA to the WDS to solve the problem of the low data security caused by the wired equivalent private (WEP) scheme used in the conventional WDS.

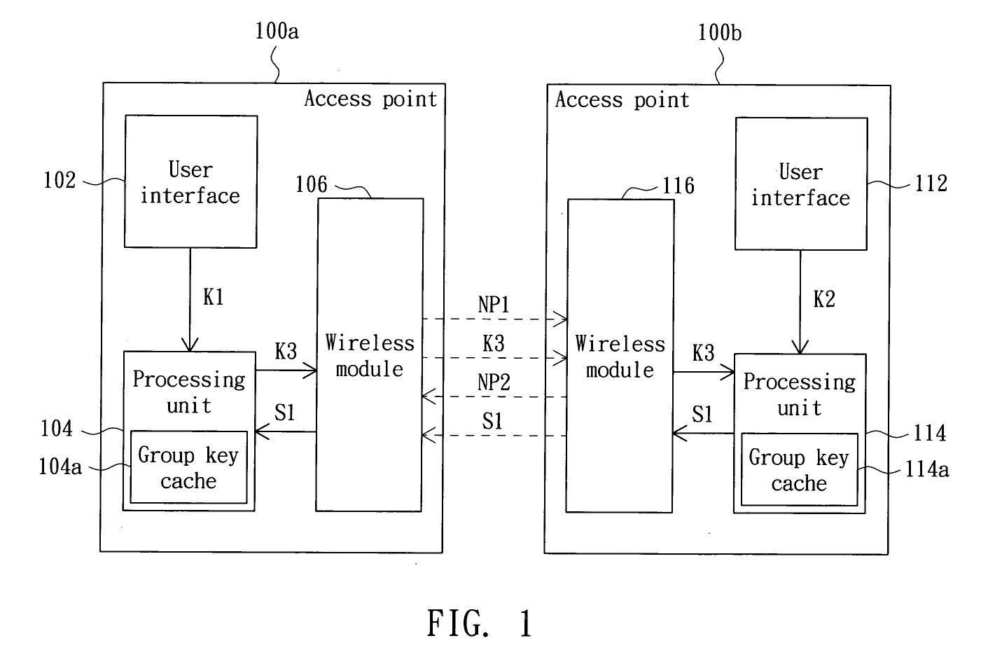

FIG. 1 is a circuit block diagram showing a transmission system, which applies the WPA to the WDS according to a preferred embodiment of the invention. Referring to FIG. 1, a transmission apparatus 100 includes APs 100a and 100b. The AP 100a includes a user interface (UI) 102, a processing unit 104 and a wireless module 106. The processing unit 104 includes a group key cache 104a. The UI 102 is electrically connected to the processing unit 104, and the processing unit 104 is electrically connected to the wireless module 106. The AP 100b includes a UI 112, a processing unit 114 and a wireless module 116. The processing unit 114 includes a group key cache 114a. The UI 112 is electrically connected to the processing unit 114, and the processing unit 114 is electrically connected to the wireless module 116. The wireless module 106 and the wireless module 116 of the APs 100a and 100b are connected to each other through a wireless path.

The user respectively sets the AP 100b and the AP 100a as peer repeaters of the AP 100a and the AP 100b through the UIs 102 and 112. The user respectively sets the PSK K1 and the PSK K2 through the UIs 102 and 112. The UIs 102 and 112 respectively output the PSK K1 and the PSK K2. The PSK K1 and the PSK K2 preferably have the same value.

The processing units 104 and 114 respectively receive the PSK K1 and the PSK K2 and respectively set the PSK K1 and the PSK K2 as the PTK K1′ (not shown) and the PTK K2′ (not shown). The processing units 104 and 114 respectively generate the PMK K3 and the PMK K4 (not shown) according to K1′ and K2′. The processing unit 104 outputs the PMK K3 through the wireless module 106, wherein the PMK K3 and the PMK K4 preferably have the same value.

The processing unit 114 outputs an acknowledgement (ACK) signal S1 through the wireless module 106 when the processing unit 114 receives the PMK K3. After the processing unit 114 outputs the ACK signal S1 through the wireless module 116, the processing unit 114 stores the PMK K3 into the group key cache 114a. After the processing unit 104 receives the ACK signal S1 through the wireless module 106, the processing unit 104 stores the PMK K3 into the group key cache 104a. At this moment, the processing units 104 and 114 encrypt/decrypt the data transmitted between the AP 100b and the AP 100a according to the PMK K3 serving as the PMK of the WPA.

The AP 100a updates the PMK K3 after every one update time. When the AP 100a wants to update the PMK K3, the processing unit 104 sets the PMK K3 as the PTK K1′ and generates an updated PMK K3′ according to the PTK K1′. The processing unit 104 replaces the original PMK K3 with the updated PMK K3′, and outputs an updated PMK K3 to the AP 100b. The data transmitted between the AP 100b and the AP 100a is encrypted/decrypted using the updated PMK K3. The wireless module 106 controls the processing unit 104 to update the PMK K3 every update time cycle.

The wireless modules 106 and 116 respectively detect whether the AP 100a and the AP 100b are still in the normal operating states through the transmitting and receiving of null packets NP1 and NP2. The wireless module 106 outputs the null packet NP1 to the wireless module 116 every one null packet transmitting cycle T1, and the wireless module 116 outputs the null packet NP2 to the wireless module 106 every one null packet transmitting cycle T2. The wireless modules 106 and 116 judge whether the null packets NP2 and NP1 respectively outputted from the wireless modules 116 and 106 are received every null packet detecting cycles D1 and D2, respectively. If not, the wireless modules 106 and 116 respectively drive the processing units 104 and 114 to respectively generate the PMK K3 and the PMK K4 according to the same PSK K1 and PSK K2. The wireless module 106 outputs the PMK K3 to the wireless module 116 so that the AP 100a and the AP 100b encrypt/decrypt the transmitted data according to the reset PMK K3.

The detailed operation of transmitting and receiving the null packets of the wireless modules 106 and 116 will be described in the following. When the wireless module 106 does not receive the wireless packet NP2 in the null packet detecting cycle D1, it means that the AP 100b is abnormal. At this moment, the AP 100a resets the PMK as the PMK K3 generated by the PSK K1, that is, the PMK generated by the AP 100a in the initial state at the first time. Next, the AP 100a outputs the PMK K3 generated according to the PSK K1 to the AP 100b. At this moment, if the AP 100b reboots, the AP 100b again generates the PTK K2′ and the PMK K4 (i.e., the PMK generated by the AP 100b in the initial state at the first time) through the PSK K2. Consequently, the AP 100a and the AP 100b have the same PMK K3 so that the AP 100a and the AP 100b may transmit the data through the PMK K3. Thereafter, the AP 100b further receives the PMK K3 outputted from the AP 100a or the updated PMK K3 so that the AP 100a and the AP 100b may perform the subsequent data transmission through the PMK K3 or the updated PMK K3. Similarly, if the wireless module 116 does not receive the wireless packet NP1 in the null packet detecting cycle D2, the operation is also similar to that described hereinabove. Consequently, the PMK can be corrected again when the AP 100a or the AP 100b becomes abnormal and needs to be rebooted.

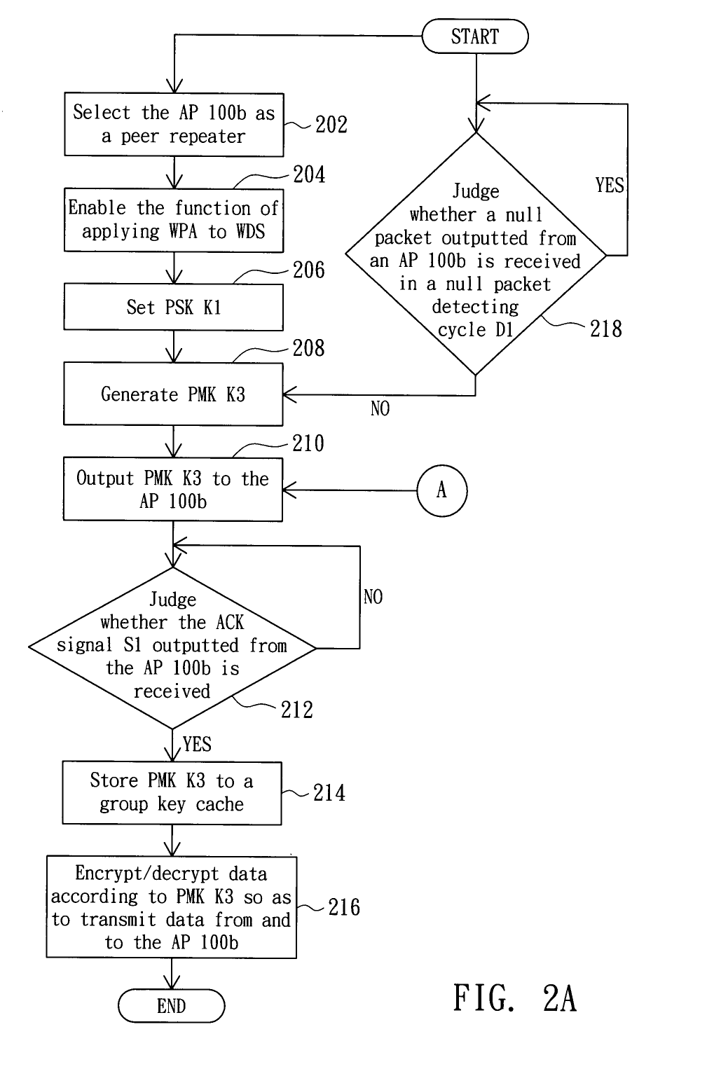

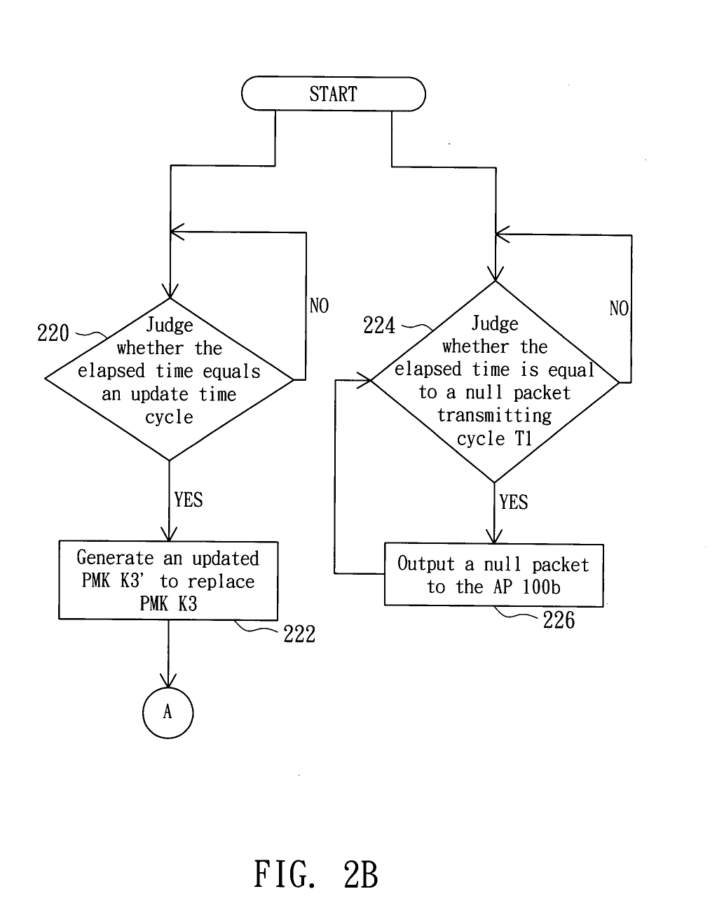

FIGS. 2A and 2B are detailed flow charts showing a data transmitting method of the WDS for encrypting/decrypting data through the WPA in a data transmitting system on the AP 100a side of FIG. 1. First, in step 202, a user interface 102a selects the AP 100b as a peer repeater. Next, step 204 is performed to enable the user interface 102a to enable the function of the AP 100a of applying the WPA to the WDS. Then, step 206 is performed to enable the user interface 102a to set the PSK K1. Next, step 208 is performed to enable the processing unit 104 to set the PSK K1 as the PTK K1′ and to generate the PMK K3 according to the PTK K1′. Then, step 210 is performed to enable the processing unit 104 to transmit the PMK K3 to the AP 100b through the wireless module 106. Next, step 212 is performed to judge whether the ACK signal S1 outputted from the AP 100b is received. If not, step 212 is repeated; or otherwise the procedure goes to step 214. In step 214, the PMK K3 is stored to the group key cache 104a. Then, step 216 is performed to encrypt/decrypt the data according to the PMK K3 stored in the group key cache 104a so that the data can be transmitted to and from the AP 100b.

In addition, the wireless module 106 further performs step 218 in parallel to judge whether the null packet NP2 transmitted from the AP 100b is received in a null packet detecting cycle D1. If not, step 208 is performed; or otherwise step 218 is performed repeatedly.

The wireless module 106 also performs step 220 in parallel to judge whether the elapsed time is equal to the update time cycle. If not, the procedure goes back to step 220; or otherwise step 222 is performed. In step 222, the PMK K1 is set as the PTK K1′, an updated PMK K3′ is generated according to the PTK K1′, and this updated PMK K3′ replaces the PMK K3 generated in step 208. Then, step 210 is performed.

The wireless module 106 further performs step 224 in parallel to judge whether the elapsed time is equal to the null packet transmitting cycle T1. If not, step 224 is repeated; or otherwise step 226 is performed. In step 226, the null packet NP1 is transmitted to the AP 100b. Thereafter, step 224 is performed repeatedly. Steps 202 to 206 are performed through the UI 102, steps 208, 210, 214, 216 and 222 are performed through the processing unit 104, and steps 212, 218, 220, 224 and 226 are performed through the wireless module 106. Steps 202 to 216, step 218, steps 220 to 222 and steps 224 to 226 are independently performed.

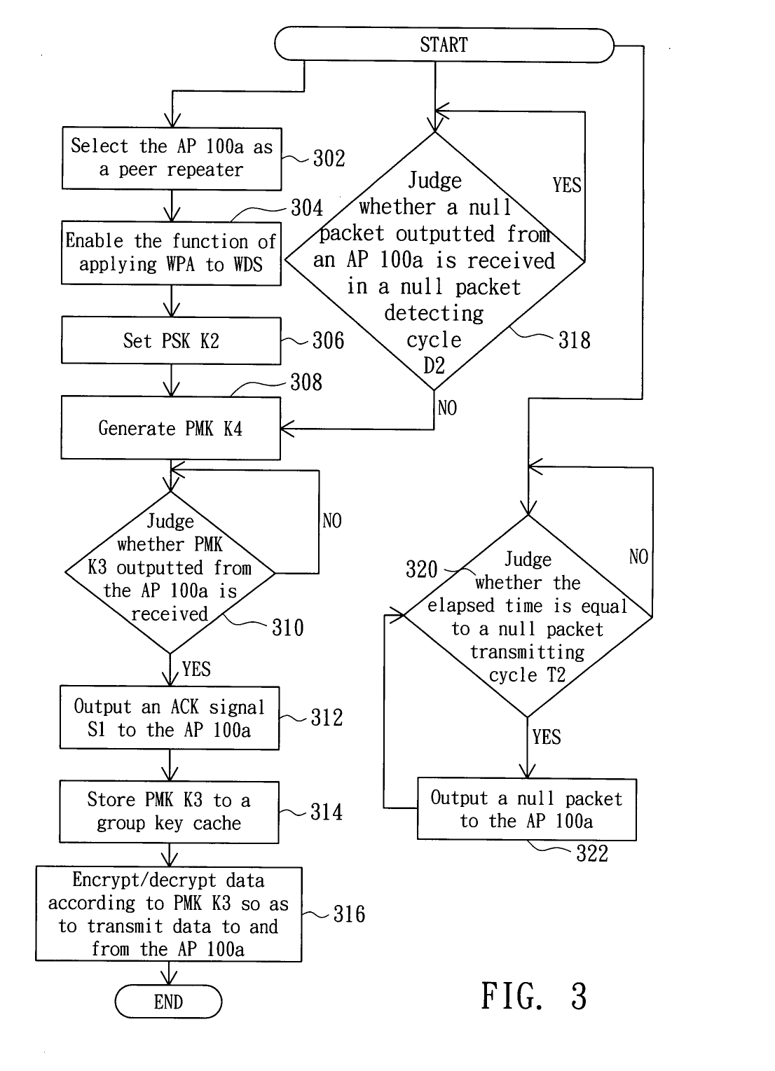

FIG. 3 is a detailed flow chart showing the data transmitting method of the WDS for encrypting/decrypting data through the WPA in a data transmitting system on the AP 100b side of FIG. 1. First, in step 302, the user interface 112 selects the AP 100a as the peer repeater. Next, in step 304, the user interface 112 enables the function of the AP 100a to apply the WPA to the WDS. Then, in step 306, the user interface 112 sets the PSK K2. Next, in step 308 the PSK K2 is set as the PTK K2′, and the PMK K4 is generated according to the PTK K2′. Then, step 310 judges whether the PMK K3 outputted from the AP 100a is received. If not, step 310 is repeated; or otherwise step 312 is performed. In step 312, the ACK signal S1 is outputted to the AP 100a. Then, step 314 is performed to store the PMK K3 to the group key cache 114a. Next, step 316 is performed to encrypt/decrypt the data according to the PMK K3 stored in the group key cache 114a.

In addition, steps 318 and 320 are performed in parallel. Step 318 judges whether the null packet NP1 transmitted from the AP 100a is received in a null packet detecting cycle D2. If not, step 308 is performed; or otherwise step 318 is repeated.

Step 320 judges whether the elapsed time is equal to the null packet transmitting cycle T2. If not, the procedure goes back to step 320; or otherwise step 322 is performed. In step 322, the null packet NP2 is transmitted to the AP 100b. Steps 302 to 306 are performed through the UI 112, steps 308 and 312 to 316 are performed through the processing unit 114, and steps 310 and 318 to 222 are performed through the wireless module 116. Steps 302 to 314, step 316 and steps 318 to 320 are independently performed.

In this embodiment, the two APs 100a and 100b are illustrated. However, the data transmitting method and apparatus of the invention are not limited to the two APs. Instead, the method and the apparatus may be applied to the WDS between three or more than three APs. Among the APs in this embodiment, for example, the master has the larger MAC address and the slave has the smaller MAC address. In this embodiment, the MAC address of the AP 100a is greater than the MAC address of the AP 100b.

The wireless modules 106 and 116 of the AP 100a and the AP 100b of this embodiment may be, for example, the 802.1x modules. The processing units 104 and 114 according to the embodiment have the better effects when the PMK K3 and the PMK K4 are generated using the PTK K1′ and the PTK K2′ according to the AES, for example, and the PMK K3 is preferably transmitted through an extensible authentication protocol encapsulation over LAN packet (EAPOL packet).

The data transmitting method and apparatus of applying the WPA to the WDS apply the WPA to the WDS between two or more than two APs. Thus, the WDS between the APs may be encrypted/decrypted according to the WPA having the higher data transmitting security. Consequently, the higher data security of the WDS between the APs may be provided.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data transmitting system of a wireless distribution system (WDS) for encrypting/decrypting data between access points (APs) through a wireless protected access (WPA), the data transmitting system comprising:
a master access point (AP), which comprises:
a first wireless module;
a first user interface for setting a pre-shared key (PSK); and
a first processing unit for setting the PSK as a first pairwise transient key (PTK) and thus generating a first pairwise master key (PMK), wherein the first processing unit outputs the first PMK, the first processing unit stores the first PMK after receiving an acknowledgement (ACK) signal through the first wireless module, and encrypts/decrypts the data according to the first PMK; and
a slave access point (AP), which comprises:
a second wireless module;
a second user interface for setting the master AP as a peer repeater and setting the PSK; and
a second processing unit for setting the PSK as a second PTK and generating a second PMK, wherein the second processing unit receives the first PMK outputted from the first processing unit, outputs the ACK signal to the master AP through the second wireless module when receiving the first PMK through the second wireless module, stores the first PMK and encrypts/decrypts the data according to the first PMK so as to transmit the data to the master AP;
wherein the first user interface also sets the slave AP as another peer repeater.

2. The system according to claim 1, wherein the first processing unit further generates an updated first PMK, replaces the first PMK with the updated first PMK, and outputs the updated first PMK to the slave AP through the first wireless module every one update time.

3. The system according to claim 1, wherein the first wireless module and the second wireless module further judge whether a first null packet and a second null packet transmitted from the slave AP and the master AP are received, respectively, every one null packet detecting cycle.

4. The system according to claim 3, wherein when the first wireless module and the second wireless module do not receive the first null packet and the second null packet respectively transmitted from the slave AP and the master AP every one null packet detecting cycle, the first wireless module and the second wireless module respectively control the first processing unit and the second processing unit to generate the first PTK and the second PTK according to the PSK and to generate the first PMK and the second PMK according to the first PTK and the second PTK, respectively.

5. The system according to claim 1, wherein the first wireless module and the second wireless module further transmit the second null packet and the first null packet to the slave AP and the master AP, respectively, every one null packet transmitting cycle.

6. The system according to claim 1, wherein the first processing unit and the second processing unit respectively generate the first PMK and the second PMK according to the first PTK and the second PTK through one advanced encryption standard (AES).

7. The system according to claim 1, wherein the first processing unit transmits the first PMK to the slave AP in an extensible authentication protocol encapsulation over LAN package (EAPOL Packet).

8. The system according to claim 1, wherein the first processing unit and the second processing unit further respectively comprise a first group key cache and a second group key cache for storing the first PMK and the second PMK, respectively.

9. The system according to claim 1, wherein each of the first wireless module and the second wireless module is an 802.1x module.

10. The system according to claim 1, wherein a media access control (MAC) address of the master AP is greater than a MAC address of the slave AP.

11. A data transmitting method of a wireless distribution system (WDS) for encrypting/decrypting data through a wireless protected access (WPA) in a data transmitting system, the data transmitting method comprises the steps of:
(a) providing a master access point (AP) and a slave AP, wherein the master AP and the slave AP respectively set the slave AP and the master AP as peer repeaters, and the master AP and the slave AP further respectively generate a pre-shared key (PSK);
(b) enabling the master AP and the slave AP to set the PSK as a first pairwise transient key (PTK) and a second PTK and generate a first pairwise master key (PMK) and a second PMK according to the first PTK and the second PTK, respectively;
(c) transmitting the first PMK to the slave AP;
(d) transmitting an acknowledgement (ACK) signal to the master AP after the slave AP receives the first PMK; and
(e) enabling, after step (d), the master AP and the slave AP to store the first PMK, and to encrypt/decrypt the data according to the first PMK, respectively.

12. The method according to claim 11, further comprising:
(f) setting the first PMK as the first PTK after one update time, generating an updated first PMK according to the first PTK, and repeating steps (c) to (e) by replacing the first PMK with the updated first PMK.

13. The method according to claim 11, wherein the master AP and the slave AP generate the first PMK and the second PMK according to the first PTK and the second PTK through an advanced encryption standard (AES), respectively.

14. The method according to claim 11, wherein the first PMK is transmitted to the slave AP in an extensible authentication protocol encapsulation over LAN packet (EAPOL Packet).

15. The method according to claim 11, further comprising the steps of:
(g1) enabling the master AP and the slave AP to respectively judge whether a first null packet and a second null packet respectively transmitted from the slave AP and the master AP are received in a null packet detecting cycle, and repeating step (b) if not;
(g2) enabling the master AP and the slave AP to respectively transmit the second null packet and the first null packet to the slave AP and the master AP after a null packet transmitting cycle.

16. The method according to claim 11, wherein a media access control (MAC) address of the master AP is greater than a MAC address of the slave AP.
